(19) United States
(12) Patent Application Publication
(10) Pub. No.: US 2014/0098278 A1
(43) Pub. Date: Apr. 10, 2014

(54) LENS BARREL AND IMAGING APPARATUS

(71) Applicant: Sony Corporation, Tokyo (JP)

(72) Inventors: Takashi Koyama, Tokyo (JP); Hideki Ootsuka, Kanagawa (JP)

(73) Assignee: SONY CORPORATION, Tokyo (JP)

(21) Appl. No.: 14/030,124

(22) Filed: Sep. 18, 2013

(30) Foreign Application Priority Data
Oct. 10, 2012 (JP) 2012-225164

(51) Int. Cl. G02B 7/04; H04N 5/225

(52) U.S. Cl. CPC G02B 7/04; H04N 5/2254
USPC 348/335; 359/701

(57) ABSTRACT

A lens barrel includes a cam ring that includes a first cam sliding part and a second cam sliding part, and that is rotated in a direction around an optical axis; a fixing and holding barrel in which the cam ring is disposed; a moving ring that includes a first cam engagement part and a second cam engagement part, and that is moved in an optical axis direction; and an optical element that is moved in connection with movement of the moving ring. In a part of a movement range of the moving ring, one of the first cam engagement part and the second cam engagement part is engaged with the first cam sliding part or the second cam sliding part, and another one of the first cam engagement part and the second cam engagement part is positioned on an outside of the cam ring in the optical axis direction.

### BACKGROUND

The present technology relates to a technical field with regard to a lens barrel and an imaging apparatus. In particular, the present technology relates to a technical field of achieving miniaturization while the sufficient moving stroke of a moving ring is secured in such a way that first cam engagement pins and second cam engagement pins, which are separately positioned in the optical axis direction, are provided in the moving ring.

Various imaging apparatuses, such as a video camera and a still camera, include a so-called collapsible type imaging apparatus in which a lens barrel having various optical components, such as a lens, or optical elements inside thereof is telescopically provided, and which enables change in zoom magnification or the like in such a way that the lens barrel is stored in an apparatus main body when photographing is not performed and the lens barrel is extended from the apparatus main body when photographing is performed (for example, refer to Japanese Unexamined Patent Application Publication No. 2008-170796).

In addition, such an imaging apparatus includes a collapsible type imaging apparatus in which an interchangeable lens provided as a lens barrel is detachable from an apparatus main body and the interchangeable lens telescopes. In such an interchangeable lens, a telescoping operation is performed by operating an operation ring, provided on an outer circumferential side, or an operating knob, and thus it is possible to perform the change in zoom magnification or perform focusing.

It is possible to achieve both miniaturization (thinness) when photographing is not performed and the secure of excellent optical performance when photographing is performed by providing the telescopical lens barrel as described above.

The imaging apparatus disclosed in Japanese Unexamined Patent Application Publication No. 2008-170796 includes a moving ring which holds optical elements, such as lens, a linear guide which supports the moving ring such that the moving ring can move in the optical axis direction, and a cam ring which is rotatable in the direction around the axis of an optical axis and which is difficult to move in the optical axis direction.

The moving ring is provided with cam pins, and cam grooves are formed in the cam ring. The moving ring includes the cam pins which are slidably engaged with the cam grooves of the cam ring, and the rotation thereof in the direction around the axis is suppressed by the linear guide.

If the cam ring is rotated by the driving force of a driving mechanism which includes a driving motor or the like in the imaging apparatus, the cam pins of the moving ring slide into the cam grooves of the cam ring, the moving ring is guided by the linear guide and is moved in the optical axis direction, and thus the telescoping operation is performed.

### SUMMARY

However, in recent years, in the above-described imaging apparatus, it is expected that an optical performance, such as securing of high zoom magnification, should be improved, and thus it is necessary to secure sufficient moving stroke of the moving ring.

In order to secure sufficient moving stroke of the moving ring, there is a method of increasing an engagement range (sliding range) with regard to the cam pins of the cam grooves in the optical axis direction by increasing the length of the cam ring and the moving ring in the optical axis direction. However, when the method is used, it is difficult to achieve the miniaturization of the lens barrel in the optical axis direction, and, in particular, it is difficult to achieve miniaturization in a collapsed state.

On the other hand, in order to secure sufficient moving stroke of the moving ring, there is a method of performing multi-stage extension, such as two-stage extension by increasing the number of moving rings. However, in this case, a plurality of moving rings overlap each other in the direction perpendicular to the optical axis, with the result that the external diameter of the lens barrel is enlarged, thereby interfering miniaturization.

In addition, there is a case in which another mechanism, such as a driving mechanism, is disposed in the lens barrel in order to rotate the cam ring. Meanwhile, in order to avoid interference between another mechanism or each unit, such as a gear part, which is related to another mechanism, and the movement regions of the cam pins of the moving ring, it is necessary to design the movement region of the moving ring to shift in the optical axis direction or in the direction perpendicular to the optical axis, and thus there is a problem in that the miniaturization of the lens barrel is interfered.

It is desirable to achieve miniaturization while sufficient moving stroke of a moving ring is secured.

According to a first embodiment of the present technology, there is provided a lens barrel including: a cam ring that includes a first cam sliding part and a second cam sliding part, and that is rotated in a direction around an optical axis; a fixing and holding barrel in which the cam ring is disposed; a moving ring that includes a first cam engagement part which is slidably engaged with the first cam sliding part and a second cam engagement part which is slidably engaged with the second cam sliding part, and that is moved in an optical axis direction by rotation of the cam ring; and an optical element that is moved in connection with movement of the moving ring, the first cam engagement part and the second cam engagement part are separately positioned in the optical axis direction, and, in at least a part of a movement range of the moving ring, one of the first cam engagement part and the second cam engagement part is engaged with the first cam sliding part or the second cam sliding part, and another one of the first cam engagement part and the second cam engagement part is positioned on an outside of the cam ring in the optical axis direction.

Accordingly, in the lens barrel, the moving ring is moved in the optical axis direction in such a way that one of the first cam engagement part and the second cam engagement part slides into the first cam sliding part or the second cam sliding part in at least a part of the movement range of the moving ring.

In the above-described lens barrel, it is preferable that the moving ring include a barrel part which is penetrated in the optical axis direction, and protruding parts which protrude from the barrel part in the optical axis direction, cam engagement pins, which respectively protrude from the protruding parts, be provided as the first cam engagement part and the second cam engagement part, that the first cam engagement part be more closely positioned on an image side in the optical axis direction than the second cam engagement part, and that the cam ring be formed with insertion holes into which the protruding parts and the first cam engagement part are inserted and which are penetrated in the optical axis direction.

Since the first cam engagement part is more closely positioned on the image side than the second cam engagement part in the optical axis direction, and the cam ring is formed with the insertion holes into which the protruding parts and the first cam engagement part are inserted and which are penetrated in the optical axis direction, the length of the cam ring in the optical axis direction is reduced.

In the above-described lens barrel, it is preferable that the insertion holes include first insertion parts into which the protruding parts are inserted, and second insertion parts into which the first cam engagement parts are inserted, and that a width of the first insertion part in a direction perpendicular to an optical axis be less than a width of the second insertion part in a direction perpendicular to the optical axis.

Since the width of the first insertion part in the direction perpendicular to the optical axis is less than the width of the second insertion part in the direction perpendicular to the optical axis, the widths of the respective parts of the insertion holes in the optical axis direction are minimally formed.

In the above-described lens barrel, it is preferable that the cam ring be formed with a third cam sliding part, and that the moving ring be provided with a third cam engagement part which is slidably engaged with the third cam sliding part, and which is present in the same position as the first cam engagement part or the second cam engagement part in the optical axis direction or is present near to the first cam engagement part or the second cam engagement part.

Since the cam ring is formed with the third cam sliding part and the moving ring is provided with the third cam engagement part which is slidably engaged with the third cam sliding part and which is present in the same position as the first cam engagement part or the second cam engagement part in the optical axis direction or is present near to the first cam engagement part or the second cam engagement part, reinforcement is performed on the engagement with the first cam sliding part and the second cam sliding part of the first cam engagement part and the second cam engagement part.

In the above-described lens barrel, it is preferable that the cam ring be provided with a driving mechanism which supplies driving force, and that the driving mechanism be disposed inside the fixing and holding barrel.

Since the cam ring is provided with the driving mechanism which supplies the driving force, and the driving mechanism is disposed inside the fixing and holding barrel, it is not necessary to connect the driving mechanism to the cam ring from the outer circumferential side of the fixing and holding barrel.

In the above-described lens barrel, it is preferable that the driving mechanism be provided with a driving motor and a circuit board which controls the driving motor, that the first cam engagement part be positioned on an outer circumferential side of the optical element, and that the driving motor and the circuit board be disposed between the first cam engagement part and the optical element.

Since the driving mechanism is provided with the driving motor and the circuit board which controls the driving motor, the first cam engagement part is positioned on the outer circumferential side of the optical element, and the driving motor and the circuit board are disposed between the first cam engagement part and the optical element, a space for the movement of the first cam engagement part does not interfere with the circuit board.

According to a second embodiment of the present technology, there is provided an imaging apparatus including: a lens barrel in which an optical system is disposed; and an imaging device that converts an optical image, which is captured through the optical system, into an electrical signal. The lens barrel includes: a cam ring that includes a first cam sliding part and a second cam sliding part, and that is rotated in a direction around an optical axis; a fixing and holding barrel in which the cam ring is disposed; a moving ring that includes a first cam engagement part which is slidably engaged with the first cam sliding part and a second cam engagement part which is slidably engaged with the second cam sliding part, and that is moved in an optical axis direction by rotation of the cam ring; and an optical element that is moved in connection with movement of the moving ring, the first cam engagement part and the second cam engagement part are separately positioned in the optical axis direction, and, in at least a part of a movement range of the moving ring, one of the first cam engagement part and the second cam engagement part is engaged with the first cam sliding part or the second cam sliding part, and another one of the first cam engagement part and the second cam engagement part is positioned on an outside of the cam ring in the optical axis direction.

Accordingly, in the imaging apparatus, in the lens barrel, one of the first cam engagement part and the second cam engagement part slides into the first cam sliding part or the second cam sliding part in at least a part of the movement range of the moving ring, and thus the moving ring is moved in the optical axis direction.

According to the first embodiment of the present technology, the lens barrel includes: a cam ring that includes a first cam sliding part and a second cam sliding part, and that is rotated in a direction around an optical axis; a fixing and holding barrel in which the cam ring is disposed; a moving ring that includes a first cam engagement part which is slidably engaged with the first cam sliding part and a second cam engagement part which is slidably engaged with the second cam sliding part, and that is moved in an optical axis direction by rotation of the cam ring; and an optical element that is moved in connection with movement of the moving ring, the first cam engagement part and the second cam engagement part are separately positioned in the optical axis direction, and, in at least a part of a movement range of the moving ring, one of the first cam engagement part and the second cam engagement part is engaged with the first cam sliding part or the second cam sliding part, and another one of the first cam engagement part and the second cam engagement part is positioned on an outside of the cam ring in the optical axis direction.

Accordingly, since the engagement of the first cam engagement part with the first cam sliding part is switched over to the engagement of the second cam engagement part with the second cam sliding part in the movement range of the moving ring, it is not necessary to perform multi-stage extension, such as two-stage extension, and it is possible to achieve the miniaturization of the lens barrel while the sufficient moving stroke of the moving ring is secured.

According to the embodiment of the present technology, the moving ring includes a barrel part which is penetrated in the optical axis direction, and protruding parts which protrude from the barrel part in the optical axis direction, cam engagement pins, which respectively protrude from the protruding parts, are provided as the first cam engagement part and the second cam engagement part, the first cam engagement part is more closely positioned on an image side in the optical axis direction than the second cam engagement part, and the cam ring is formed with insertion holes into which the protruding parts and the first cam engagement part are inserted and which are penetrated in the optical axis direction.

Accordingly, it is possible to increase the moving stroke of the moving ring while the length of the cam ring in the optical axis direction is reduced, and it is possible to achieve miniaturization by securing a space for components on at least one side of the cam ring of the inside of the lens barrel in the optical axis direction.

According to the embodiment of the present technology, the insertion holes include first insertion parts into which the protruding parts are inserted, and second insertion parts into which the first cam engagement parts are inserted, and a width of the first insertion part in a direction perpendicular to an optical axis is less than a width of the second insertion part in a direction perpendicular to the optical axis.

Accordingly, the widths of the respective parts of the insertion holes in the optical axis direction are minimally formed, and thus it is possible to thicken the thickness of the cam ring and it is possible to increase the stiffness of the cam ring to that extent.

According to the embodiment of the present technology, the cam ring is formed with a third cam sliding part, and the moving ring is provided with a third cam engagement part which is slidably engaged with the third cam sliding part, and which is present in the same position as the first cam engagement part or the second cam engagement part in the optical axis direction or is present near to the first cam engagement part or the second cam engagement part.

Accordingly, reinforcement is performed on the engagement of the first cam engagement part and the second cam engagement part with the first cam sliding part and the second cam sliding part, and thus it is possible to prevent the moving ring from falling from the cam ring when vibrations or shocks occur.

According to the embodiment of the present technology, cam ring is provided with the driving mechanism which supplies the driving force, and the driving mechanism is disposed inside the fixing and holding barrel.

Accordingly, a configuration is not necessary which connects the driving mechanism to the cam ring from the outer circumferential side of the fixing and holding barrel, and thus it is possible to achieve the simplification and the miniaturization of the configuration of the lens barrel to that extent.

According to the embodiment of the present technology, driving mechanism is provided with a driving motor and a circuit board which controls the driving motor, the first cam engagement part is positioned on an outer circumferential side of the optical element, and the driving motor and the circuit board are disposed between the first cam engagement part and the optical element.

Accordingly, it is possible to effectively use the internal space of the lens barrel as a space for disposing the circuit board, it is possible to achieve miniaturization of the lens barrel, and it is possible to secure a proper operation of the moving ring while a space for moving the first cam engagement part does not interfere with the circuit board.

According to the second embodiment of the present technology, the imaging apparatus includes: a lens barrel in which an optical system is disposed; and an imaging device that converts an optical image, which is captured through the optical system, into an electrical signal. The lens barrel includes: a cam ring that includes a first cam sliding part and a second cam sliding part, and that is rotated in a direction around an optical axis; a fixing and holding barrel in which the cam ring is disposed; a moving ring that includes a first cam engagement part which is slidably engaged with the first cam sliding part and a second cam engagement part which is slidably engaged with the second cam sliding part, and that is moved in an optical axis direction by rotation of the cam ring; and an optical element that is moved in connection with movement of the moving ring, the first cam engagement part and the second cam engagement part are separately positioned in the optical axis direction, and, in at least a part of a movement range of the moving ring, one of the first cam engagement part and the second cam engagement part is engaged with the first cam sliding part or the second cam sliding part, and another one of the first cam engagement part and the second cam engagement part is positioned on an outside of the cam ring in the optical axis direction.

Accordingly, since the engagement of the first cam engagement part with the first cam sliding part is switched over to the engagement of the second cam engagement part with the second cam sliding part in the movement region of the moving ring, it is not necessary to perform multi-stage extension such as two-stage extension and it is possible to achieve the miniaturization of the imaging apparatus while the sufficient moving stroke of the moving ring is secured.

### BRIEF DESCRIPTION OF THE DRAWINGS

FIG. 1 is a view illustrating the best modes of a lens barrel and an imaging apparatus according to an embodiment of the present technology together with FIGS. 2 to 14, and FIG. 1 is a schematic perspective view illustrating the imaging apparatus;

FIG. 2 is a perspective view illustrating the imaging apparatus when an apparatus main body and the lens barrel are separated from each other;

FIG. 3 is a side view illustrating the lens barrel;

FIG. 4 is an enlarged perspective view illustrating the lens barrel when a fixing and holding barrel or the like is removed;

FIG. 5 is a cross-sectional view illustrating the lens barrel;

FIG. 6 is an enlarged perspective view illustrating a first group moving ring;

FIG. 7 is an enlarged perspective view illustrating the first group moving ring when viewed from a direction which is different from that of FIG. 6;

FIG. 8 is an enlarged perspective view illustrating a part of the first group moving ring;

FIG. 9 is an enlarged perspective view illustrating a first group unit;

FIG. 10 is an enlarged perspective view illustrating the first group unit when viewed from a direction which is different from that of FIG. 9;

FIG. 11 is an enlarged perspective view illustrating a second group unit and a third group unit;

FIG. 12 is a cross-sectional view illustrating the lens barrel in a wide angle-end state;

FIG. 13 is a cross-sectional view illustrating the lens barrel in a telephoto-end state; and

FIG. 14 is a block diagram illustrating the imaging apparatus.

### DETAILED DESCRIPTION OF EMBODIMENTS

Hereinafter, a best mode for implementing a lens barrel and an imaging apparatus according to an embodiment of the present technology will be described with reference to the accompanying drawings.

The best mode shown below is acquired by applying the imaging apparatus according to an embodiment of the present technology to a still camera and applying a lens barrel according to the embodiment of the present technology to a lens barrel which is provided as the interchangeable lens of the still camera.

Also, the application range according to the present technology is not limited to the still camera and the lens barrel which is provided as the interchangeable lens of the still camera. For example, it is possible to widely apply the present technology to a video camera or various imaging apparatuses which are embedded in other equipment and to various lens barrels which are provided in the imaging apparatuses.

In addition, the lens barrel is not limited to the interchangeable lens, and it is possible to widely apply the lens barrel to a collapsible type lens which is disposed inside the imaging apparatus in a storage state and which is extended in a use state. Also, in the imaging apparatus, it is possible to widely apply the lens barrel to a collapsible type lens barrel which is disposed inside the imaging apparatus in the storage state and is extended in the use state.

In description below, it is assumed that back and forth, up and down, and right and left directions are shown from a direction viewed by a photographer when photographing is performed using a still camera. Therefore, a subject side is a front side and a photographer side is a rear side.

Also, the back and forth, up and down, and right and left directions which are shown below are used for convenience of explanation, and an embodiment of the present technology is not limited to the directions.

### Configuration of Imaging Apparatus

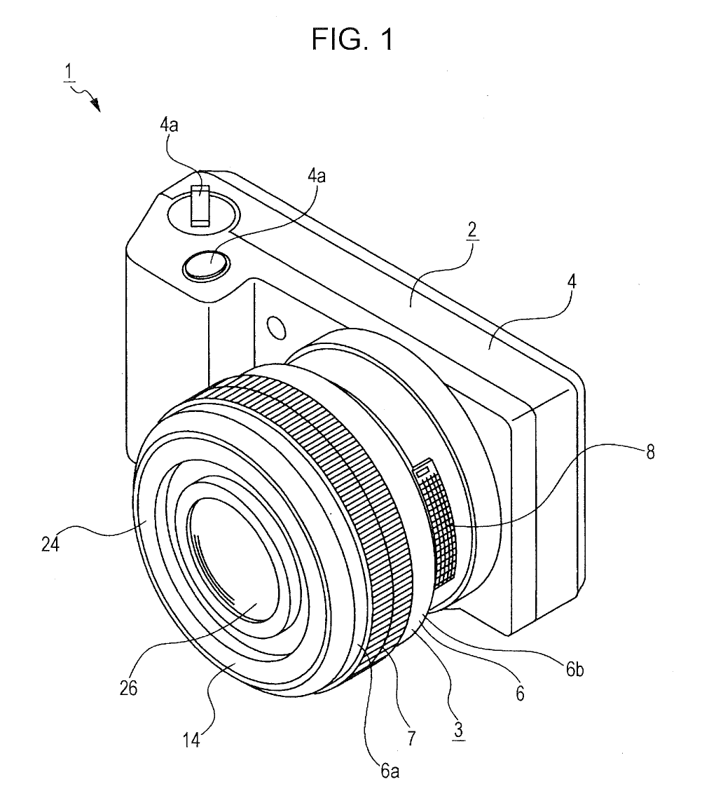

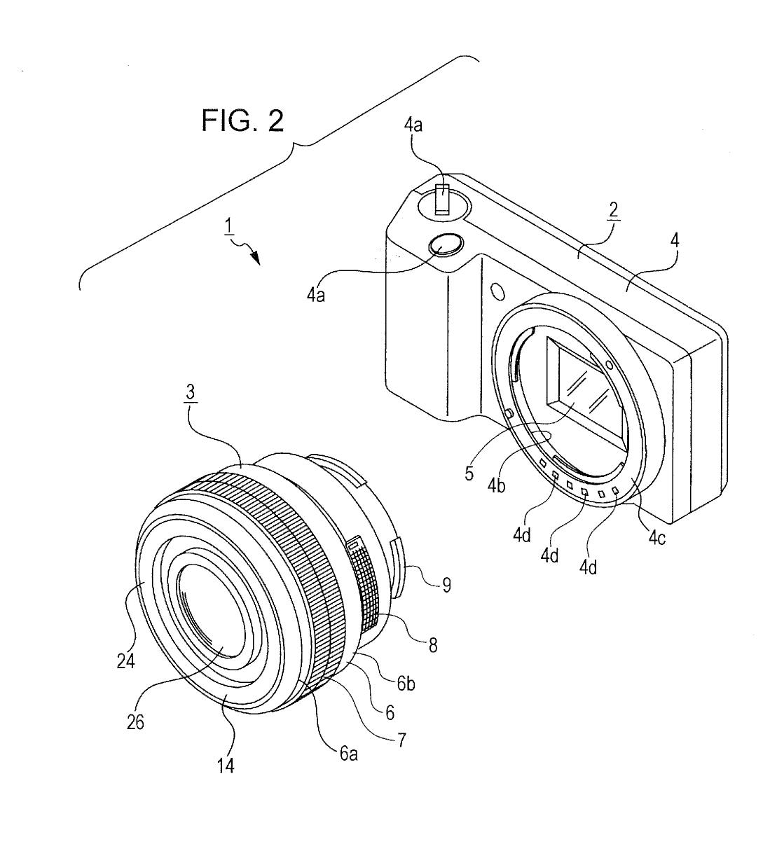

An imaging apparatus 1 includes an apparatus main body 2 and a lens barrel (interchangeable lens) 3 (refer to FIGS. 1 and 2). Also, in a collapsible type imaging apparatus including a lens barrel which is assembled in the apparatus main body 2 and which is extended when the imaging apparatus is used, the imaging apparatus includes only the apparatus main body which has the lens barrel.

The apparatus main body 2 is formed in such a way that respective necessary parts are disposed inside and outside of a housing 4.

Various input operation units 4a, 4a, . . . are disposed on the upper surface of the housing 4. For example, a power button, a shutter button, a mode switching knob, and the like are provided as the input operation units 4a, 4a, . . . .

Various input operation units and a display, which are not shown in the drawing, are disposed on the rear surface of the housing 4. For example, a zooming switch, a mode switching knob, and the like are provided as the input operation units.

A circular aperture 4b is formed on the front surface of the housing 4, and the circumferential part of the aperture 4b is provided as a mounting part 4c for fixing the lens barrel 3. Connection terminals 4d, 4d, . . . are aligned and provided in the circumferential direction on the front surface of the mounting part 4c.

An imaging device 5, such as a Charge Coupled Device (CCD) or a Complementary Metal-Oxide Semiconductor (CMOS), is disposed inside the housing 4, and the imaging device 5 is positioned on the rear side of the aperture 4b.

### Configuration of Lens Barrel

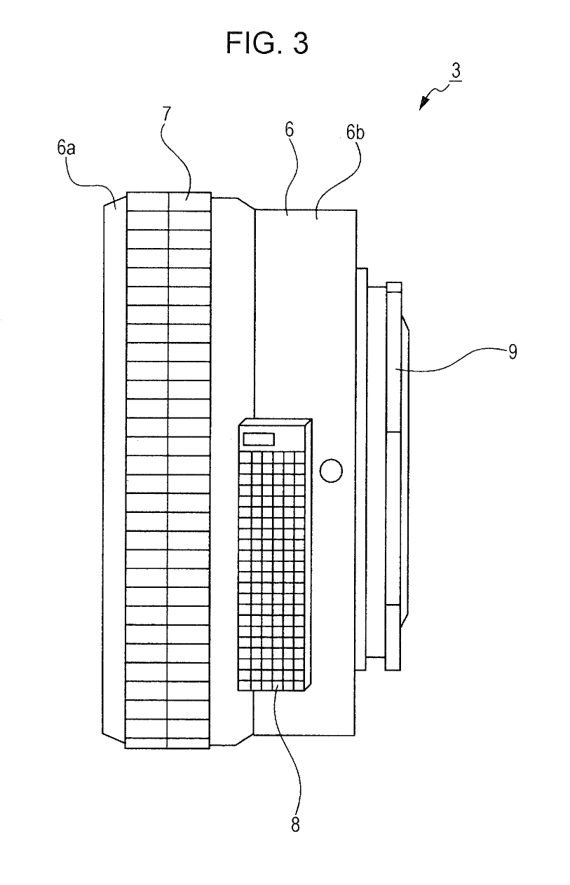

The lens barrel 3 includes a fixing and holding barrel 6, and is formed in such a way that respective necessary parts are disposed inside and outside of the fixing and holding barrel 6 (refer to FIGS. 3 to 5).

A fixing and holding barrel 6 includes a fixed holding ring 6a which is formed in a substantially cylindrical shape, respectively, and an exterior cover 6b which is fixed to the fixed holding ring 6a in a frame form through adhesion or the like. The exterior cover 6b has a length which is shorter than that of the fixed holding ring 6a in the axial direction, and is fitted to a part which does not include the front end side part of the fixed holding ring 6a.

An operation ring 7 is rotatably supported on the outer circumference of the fixing and holding barrel 6. The operation ring 7 is supported by a front end side part of the fixed holding ring 6a and is provided as an operation unit which performs zooming and focusing when the operation ring is rotated. Also, in the imaging apparatus 1, it is possible to switch over the zooming operation and the focusing operation of the operation ring 7 in accordance with an operation performed on the input operation units 4a of the apparatus main body 2.

A zoom lever 8 is supported on the outer circumferential surface of the fixing and holding barrel 6. The zoom lever 8 is operated in the circumferential direction with regard to the fixing and holding barrel 6. When the zoom lever 8 is operated, zooming is performed at a predetermined speed.

An annular mounting member 9 is fitted to the inner circumferential surface of the rear end part of the fixing and holding barrel 6. The mounting member 9 is fitted to the mounting part 4c when the lens barrel 3 is mounted on the apparatus main body 2.

Contact points 10, 10, . . . are disposed on the lower end part of the mounting member 9. The contact points 10, 10, . . . are connected to the connection terminals 4d, 4d, . . . of the apparatus main body 2 when the lens barrel 3 is mounted on the apparatus main body 2. The electric conduction between the lens barrel 3 and the apparatus main body 2 is achieved by connecting the contact points 10, 10, . . . to the connection terminals.

An annular light blocking ring 11 is fitted to the inner circumferential surface of the rear end part of the mounting member 9.

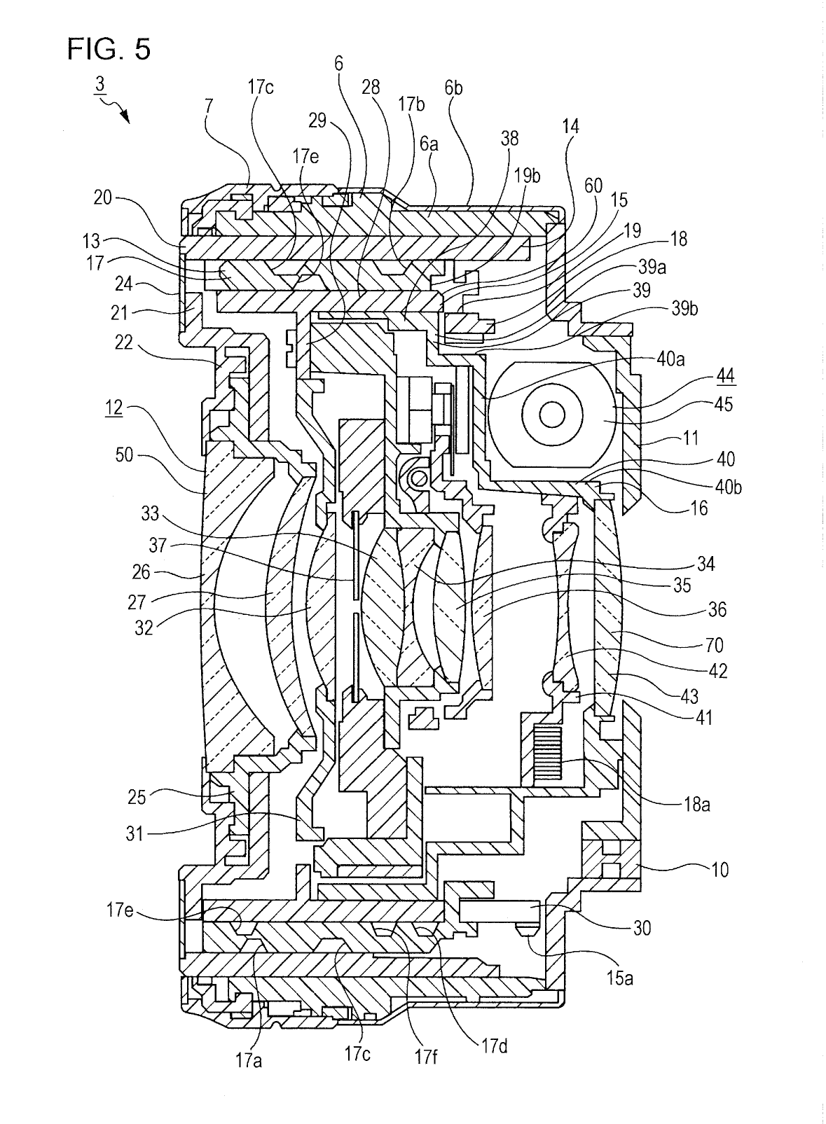

A lens unit 12 is disposed inside the fixing and holding barrel 6. The lens unit 12 includes a cam ring 13, a first group moving ring 14, a second group moving ring 15, and a third group moving ring 16 (refer to FIG. 5).

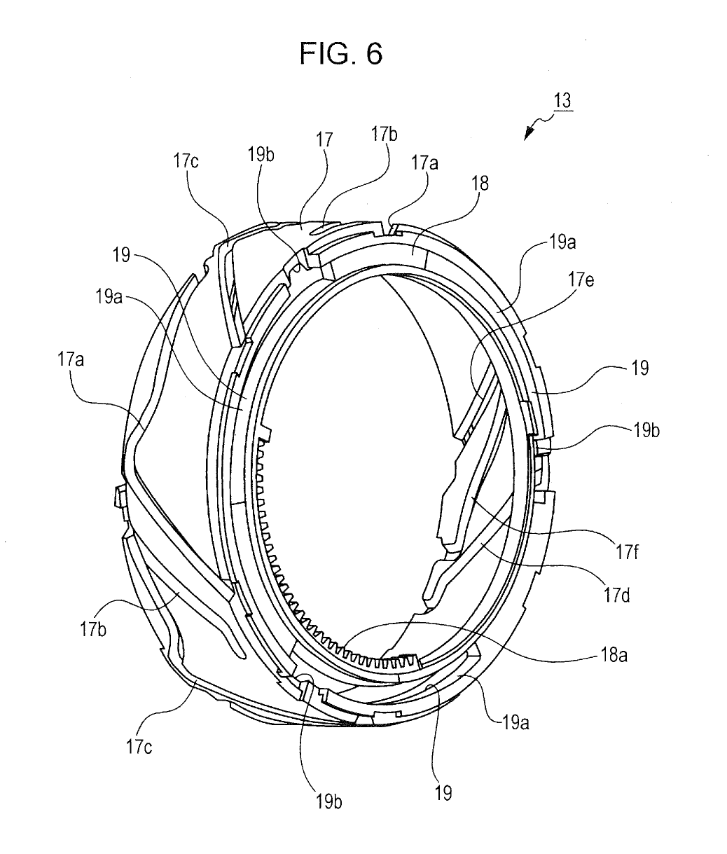

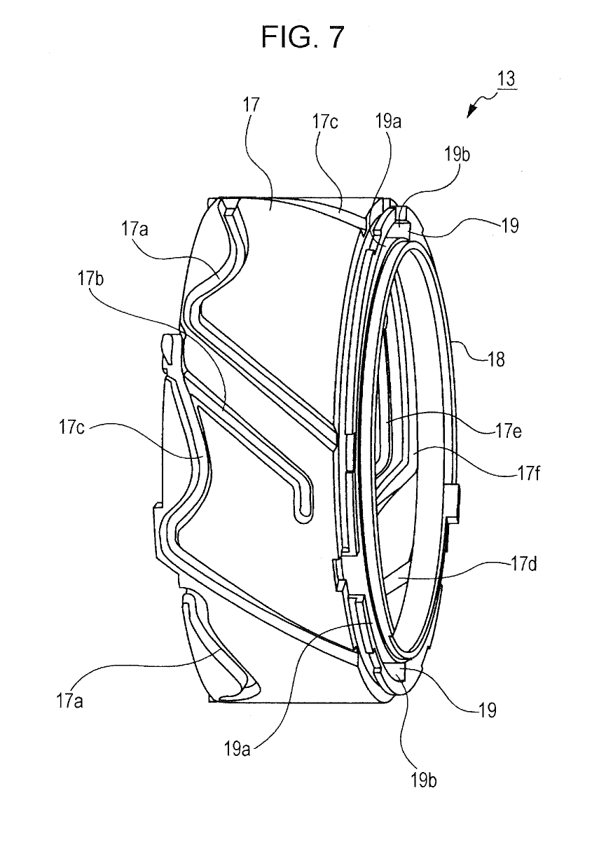

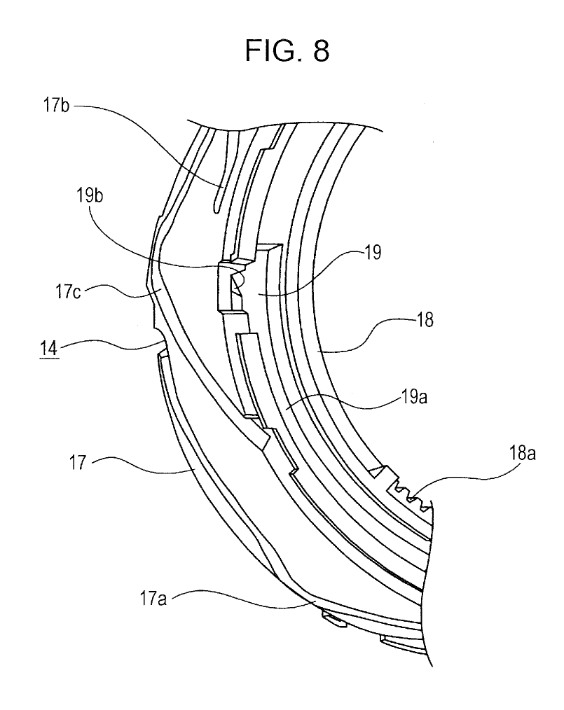

The cam ring 13 includes a substantially cylindrical cam groove forming part 17, the axial direction of which is the back and forth direction (optical axis direction), and an internal flange part 18 which is projected from the rear end part of the cam groove forming part 17 to the inner side (refer to FIGS. 6 to 8). The cam ring 13 is rotatably supported by the fixing and holding barrel 6 through bayonet connection, and can be rotated in the direction around an axis of the fixing and holding barrel 6.

First cam grooves 17a, 17a, 17a, second cam grooves 17b, 17b, 17b, and third cam grooves 17c, 17c, 17c are separately formed on the outer circumferential surface of the cam groove forming part 17 in the circumferential direction. The first cam grooves 17a, 17a, 17a, the second cam grooves 17b, 17b, 17b, and the third cam grooves 17c, 17c, 17c function as a cam sliding part, respectively.

The first cam grooves 17a, 17a, 17a and the third cam grooves 17c, 17c, 17c are formed in positions ranging from the front end to near to the rear end of the cam groove forming part 17, and are open on the rear side. Each of the second cam grooves 17b, 17b, 17b includes a rear end part which is formed in a position near to the rear end of the cam groove forming part 17.

First cam sliding grooves 17d, 17d, 17d, second cam sliding grooves 17e, 17e, 17e, and third cam sliding grooves 17f, 17f, 17f are separately formed on the inner circumferential surface of the cam groove forming part 17 in the circumferential direction. The first cam sliding grooves 17d, 17d, 17d and the second cam sliding grooves 17e, 17e, 17e function as a cam sliding part, respectively.

The first cam sliding grooves 17a, 17a, 17a are formed in positions ranging from the front end to near to the rear end of the cam groove forming part 17, and are open on the rear side. Each of the second cam sliding grooves 17b, 17b, 17b and the third cam sliding grooves 17c, 17c, 17c includes a rear end part which is formed in a position near to the rear end of the cam groove forming part 17.

Insertion holes 19, 19, 19 are separately formed in the internal flange part 18 in the circumferential direction. Each of the insertion holes 19 includes a first insertion part 19a which is extended in the circumferential direction, and a second insertion part 19b which communicates with one end of the first insertion part 19a in the circumferential direction. The width of the first insertion part 19a in the direction perpendicular to the optical axis is less than the width of the second insertion part 19b in the direction perpendicular to the optical axis. The rear end parts of the first cam sliding grooves 19d are positioned in the second insertion parts 19b.

Gears 18a are formed in the inner circumferential part of the internal flange part 18.

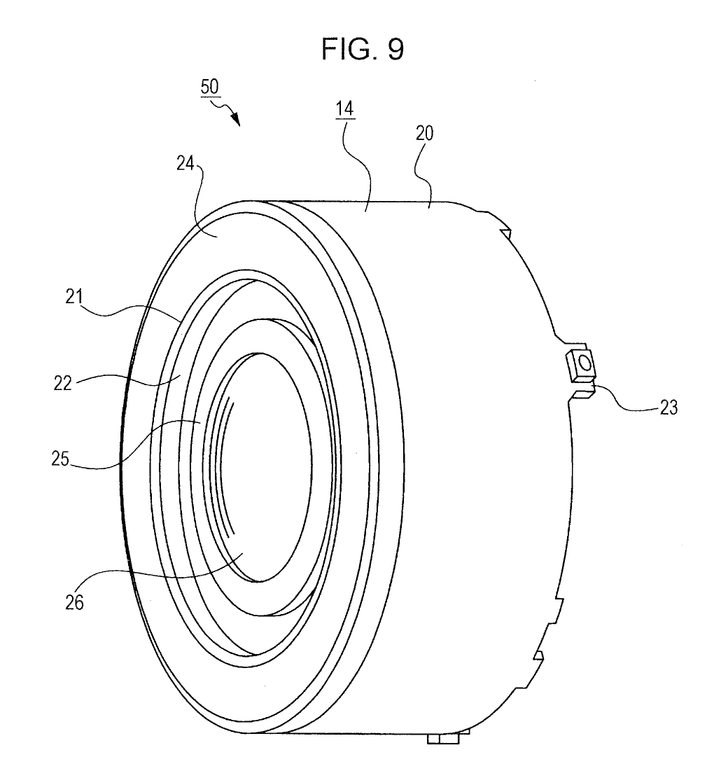

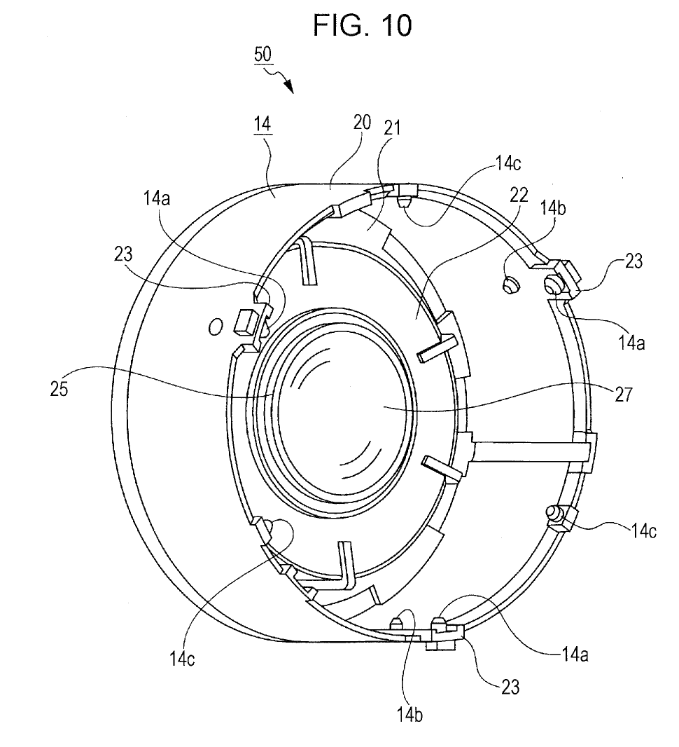

The first group moving ring 14 includes a substantially cylindrical circular barrel part 20, an axial direction of which is the back and forth direction, an projecting part 21 which is projected on the inner side from the front end part of the circular barrel part 20, and a holding part 22 which is continuously provided in the inner circumferential part of the projecting part 21 (refer to FIGS. 5, 9, and 10). The first group moving ring 14 is guided by the cam ring 13 in the optical axis direction (back and forth direction).

Pin protruding parts 23, 23, 23 protrude on the rear side from the rear end of the circular barrel part 20. The pin protruding parts 23, 23, 23 are separately positioned in the circumferential direction. First cam engagement pins 14a, 14a, 14a which protrude to the inner side, respectively, are provided in the pin protruding parts 23, 23, 23. Second cam engagement pins 14b, 14b, 14b which protrude to the inner side in positions near to the rear end of the circular barrel part 20 are separately provided in the circumferential direction, and the second cam engagement pins 14b, 14b, 14b are positioned on the front side of the first cam engagement pins 14a, 14a, 14a, respectively. Third cam engagement pins 14c, 14c, 14c which protrude to the inner side are separately provided in the rear end part of the circular barrel part 20 in the circumferential direction, and each of the third cam engagement pins 14c, 14c, 14c is positioned between the first cam engagement pins 14a, 14a, 14a in the circumferential direction.

The first cam engagement pins 14a, 14a, 14a, the second cam engagement pins 14b, 14b, 14b, and the third cam engagement pins 14c, 14c, 14c function as a cam engagement part, respectively.

A circular annular front panel 24 is fixed to the front surface of the projecting part 21.

A lens holding frame 25 is fixed to the holding part 22. The lens holding frame 25 holds lenses 26 and 27 which function as optical elements.

The first group unit 50 includes the first group moving ring 14, the front panel 24, the lens holding frame 25, and the lenses 26 and 27 which are described above.

The first group moving ring 14 includes the circular barrel part 20 which is positioned on the outer circumferential side of the cam ring 13, and the projecting part 21 which is positioned on the front side of the cam groove forming part 17 of the cam ring 13. The first group moving ring 14 includes the first cam engagement pins 14a, 14a, 14a which are slidably engaged with the respective first cam grooves 17a, 17a, 17a of the cam ring 13, the second cam engagement pins 14b, 14b, 14b which are slidably engaged with the respective second cam grooves 17b, 17b, 17b of the cam ring 13, and the third cam engagement pins 14c, 14c, 14c which are slidably engaged with the respective third cam grooves 17c, 17c, 17c of the cam ring 13.

As will be described later, the first group moving ring 14 is moved in the optical axis direction in such a way that the first cam engagement pins 14a slide into the first cam grooves 17a or that the second cam engagement pins 14b slide into the second cam grooves 17b.

Also, the third cam engagement pins 14c of the first group moving ring 14 are engaged with the third cam grooves 17c of the cam ring 13 while predetermined gaps are provided in the width direction.

Since the third cam engagement pins 14c are engaged with the third cam grooves 17c while the predetermined gaps are provided in the width direction as described above, it is difficult for the engagement state between the third cam engagement pins 14c and the third cam grooves 17c to make an effect on the slide of the first cam engagement pins 14a and the second cam engagement pins 14b with regard to the first cam grooves 17a and the second cam grooves 17b.

Therefore, it is possible to secure smooth movement state of the first group moving ring 14 in the optical axis direction.

In addition, since the third cam engagement pins 14c are engaged with the third cam grooves 17c, reinforcement is performed on the engagement of the first cam engagement pins 14a and the second cam engagement pins 14b with regard to the first cam grooves 17a and the second cam grooves 17b. Therefore, for example, it is possible to prevent the first group moving ring 14 from falling out of the cam ring 13 when vibrations or shocks occur due to dropping of the lens barrel 3.

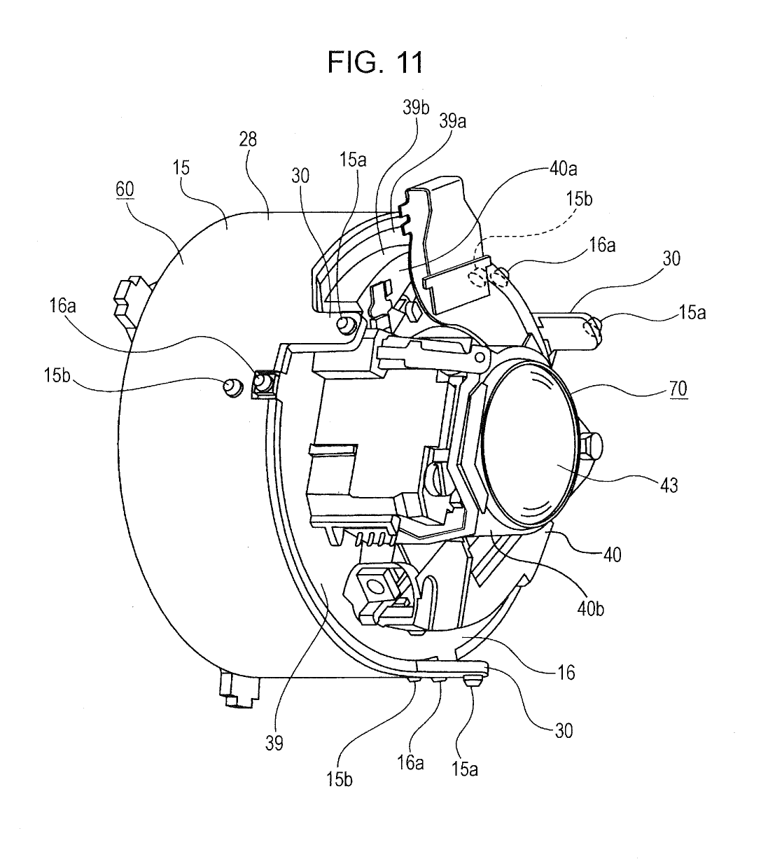

The second group moving ring 15 includes a substantially cylindrical barrel part 28, an axial direction of which is the back and forth direction, and a fitting part 29 which is projected on the inner side from the inner circumferential surface of the barrel part 28 (refer to FIGS. 5 and 11). The second group moving ring 15 is guided by the first group moving ring 14 in the optical axis direction (back and forth direction).

Protruding parts 30, 30, 30 protrude on the rear side from the rear end of the barrel part 28, and the protruding parts 30, 30, 30 are separately positioned in the circumferential direction. Rear-side cam engagement pins 15a, 15a, 15a which respectively protrude to the outside are provided in the protruding parts 30, 30, 30. Front-side cam engagement pins 15b, 15b, 15b which protrude to the outside are separately provided in positions near to the rear end of the barrel part 28 in the circumferential direction. The rear-side cam engagement pins 15a, 15a, 15a and the front-side cam engagement pins 15b, 15b, 15b respectively function as cam engagement parts.

An element holding frame 31 is fitted to the fitting part 29. Lenses 32, 33, 34, 35, and 36 which function as optical elements are held by the element holding frame 31. A diaphragm unit 37 is disposed inside the element holding frame 31.

A second group unit 60 includes the second group moving ring 15, the element holding frame 31, the lenses 31, 32, 33, 34, 35, and 36 and the diaphragm unit 37 which are described above.

The second group moving ring 15 includes the barrel part 28 which is positioned on the inner circumferential side of the cam ring 13, the rear-side cam engagement pins 15a, 15a, 15a which are slidably engaged with the respective first cam sliding grooves 17d, 17d, 17d of the cam ring 13, and the front-side cam engagement pins 15b, 15b, 15b which are slidably engaged with the respective second cam sliding grooves 17e, 17e, 17e of the cam ring 13. The second group moving ring 15 is movably supported by a guide, which is not shown in the drawing, in the optical axis direction.

Accordingly, the second group unit 60 is guided by the guide and is moved in the optical axis direction in such a way that the cam ring 13 is rotated in the direction around the axis.

The third group moving ring 16 is formed in an annular shape, the axial direction of which is the back and forth direction, and is provided with a front side part 38, an intermediate part 39, and a rear side part 40 which are sequentially continued from the front side. The third group moving ring 16 is guided by the second group moving ring 15 in the optical axis direction (back and forth direction). The front side part 38 is cylindrically formed. The intermediate part 39 includes an outer circumferential part 39a which is projected on the inner side from the rear end part of the front side part 38, and a circumferential part 39b which protrudes on the rear side from the inner circumferential part of the outer circumferential part 39a. The rear side part 40 includes an annular part 40a which is projected on the inner side from the rear end part of the circumferential part 39b, and a circumferential surface part 40b which protrudes on the rear side from the inner circumferential part of the annular part 40a.

The third group moving ring 16 is provided with cam followers 16a, 16a, 16a which respectively protrude to the outside in the rear end part of the front side part 38 and which are separated in the circumferential direction.

A holding body 41 and a lens 42 which is held by the holding body 41 are disposed inside the rear side part 40. A lens 43 which is held by the rear end part of the rear side part 40 is positioned on the rear side of the lens 42. The lenses 42 and 43 function as the optical elements.

The third group unit 70 includes the third group moving ring 16, the holding body 41, and the lenses 42 and 43 which are described above.

The third group moving ring 16 includes the front side part 38 which is positioned on the inner circumferential side of the barrel part 28 of the second group moving ring 15, and the cam followers 16a, 16a, 16a which are slidably engaged with the respective third cam sliding grooves 17f, 17f, 17f of the cam ring 13 while the cam followers 16a, 16a, 16a protrude to the outside of the barrel part 28. The third group moving ring 16 is movably supported by a guide body, which is not shown in the drawing, in the optical axis direction.

Therefore, the third group unit 70 is guided to the guide body and is moved in the optical axis direction in such a way that the cam ring 13 is rotated in the direction around the axis.

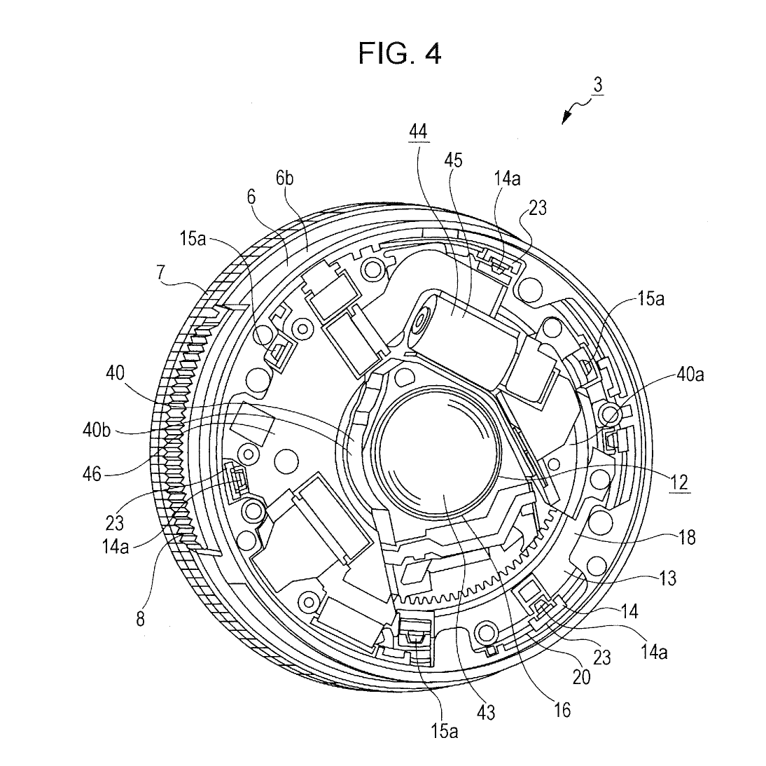

A driving mechanism 44 is disposed in the rear end part of the inside of the fixing and holding barrel 6 (refer to FIGS. 4 and 5). The driving mechanism 44 includes a driving motor 45 which is a driving source, a circuit board 46 which controls the driving motor 45, and a decelerating gear group which is rotated by the driving motor 45 and is not shown in the drawing. The decelerating gear group is engaged with the gears 18a which are provided in the internal flange part 18 of the cam ring 13.

The driving mechanism 44 is disposed in a space which is formed on the outer circumferential side of the circumferential surface part 40b on the rear side of the annular part 40a in the rear side part 40 of the third group moving ring 16.

Since the driving mechanism 44 is disposed inside the fixing and holding barrel 6 as described above, a configuration in which the driving mechanism 44 is connected to the cam ring 13 from the outer circumferential side of the fixing and holding barrel 6 is not necessary, and thus it is possible to achieve simplification and miniaturization of the configuration of the lens barrel 3 to that extent.

The circuit board 46 of the driving mechanism 44 is formed in a substantially arched shape when viewed from the back and forth direction, is disposed to face the back and forth direction on the outer circumferential side of the circumferential surface part 40b, and is disposed between the rear-side cam engagement pins 15a, 15a, 15a of the second group moving ring 15 and the lenses 35 and 36.

Therefore, it is possible to effectively use the internal space of the lens barrel 3 as a space for disposing the circuit board 46, and thus it is possible to achieve miniaturization of the lens barrel 3. Further, it is possible to secure a proper operation of the second group moving ring 15 while a space for moving the rear-side cam engagement pins 15a, 15a, 15a does not interfere with the circuit board 46.

### Operation of Lens Barrel

Subsequently, an operation of the lens barrel 3 will be described (refer to FIGS. 5, 12, and 13).

If power is not supplied to the apparatus main body 2 when the lens barrel 3 is mounted on the apparatus main body 2, the lens barrel 3 is in a collapsed state (refer to FIG. 5). The collapsed state is a state in which the lens barrel 3 is the most shortened.

In the collapsed state, all of the first group moving ring 14, the second group moving ring 15, and the third group moving ring 16 are positioned at the rear end of a movement range.

In the collapsed state, the first group moving ring 14 includes the pin protruding parts 23, 23, 23 which are positioned on the rear side of the cam ring 13, and the first cam engagement pins 14a, 14a, 14a which are provided in the pin protruding parts 23, 23, 23 and which are not engaged with the first cam grooves 17a, 17a, 17a. At this time, the second cam engagement pins 14b, 14b, 14b of the first group moving ring 14 are slidably engaged with the respective second cam grooves 17b, 17b, 17b of the cam ring 13, and thus the third cam engagement pins 14c, 14c, 14c are slidably engaged with the respective third cam grooves 17c, 17c, 17c of the cam ring 13.

In the collapsed state, the second group moving ring 15 includes the protruding parts 30, 30, 30 and the rear-side cam engagement pins 15a, 15a, 15a which are positioned on the rear side of the cam ring 13 while being inserted into the respective insertion holes 19, 19, 19 of the cam ring 13, and the rear-side cam engagement pins 15a, 15a, 15a which are not engaged with the first cam sliding grooves 17d, 17d, 17d. At this time, the front-side cam engagement pins 15b, 15b, 15b of the second group moving ring 15 are slidably engaged with the respective second cam sliding grooves 17e, 17e, 17e of the cam ring 13.

In the collapsed state, the third group moving ring 16 includes the cam followers 16a, 16a, 16a which are slidably engaged with the respective third cam sliding grooves 17f, 17f, 17f of the cam ring 13.

If the input operation unit (power button) 4a of the apparatus main body 2 is operated and power is supplied in the collapsed state, power is supplied to the driving mechanism 44 through the connection terminals 4d, 4d, . . . and the contact points 10, 10, . . . , and thus the operation of the driving mechanism 44 starts.

If the driving mechanism 44 is operated, the driving motor 45 is rotated, driving force is transmitted to the gears 18a from the decelerating gear group, and thus the cam ring 13 is rotated in one direction around the axis.

If the cam ring 13 is rotated, first, the second cam engagement pins 14b and the third cam engagement pins 14c of the first group moving ring 14 respectively slide into the second cam grooves 17b and the third cam grooves 17c, movement to the front side of the first group moving ring 14 starts, and thus the first group unit 50 is moved. At this time, the front-side cam engagement pins 15b of the second group moving ring 15 and the cam followers 16a of the third group moving ring 16 respectively slide into the second cam sliding grooves 17e and the third cam sliding grooves 17f. However, since the front-side cam engagement pins 15b and the cam followers 16a respectively slide into the parts of the second cam sliding grooves 17e and the third cam sliding grooves 17f which are extended in the direction perpendicular to the optical axis, the second group moving ring 15 and the third group moving ring 16 are not moved in the optical axis direction.

If the first group unit 50 is moved to the front side, the first cam engagement pins 14a of the first group moving ring 14 are inserted into the first cam grooves 17a of the cam ring 13 and slide into the first cam grooves 17a. Accordingly, the first group moving ring 14 is moved to the front side in such a way that the first cam engagement pins 14a slide into the first cam grooves 17a and the second cam engagement pins 14b slide into the second cam grooves 17b.

The first group unit 50 is moved up to the front end of the movement range. However, immediately before the first group unit 50 is moved up to the front end, the second cam engagement pins 14b of the first group moving ring 14 are positioned on the front side of the cam ring 13, and thus engagement with the second cam grooves 17b is released. Accordingly, in the state immediately before the first group unit 50 is moved up to the front end of the movement range, the first group unit 50 is moved to the front side in such a way that the first cam engagement pins 14a slide into the first cam grooves 17a.

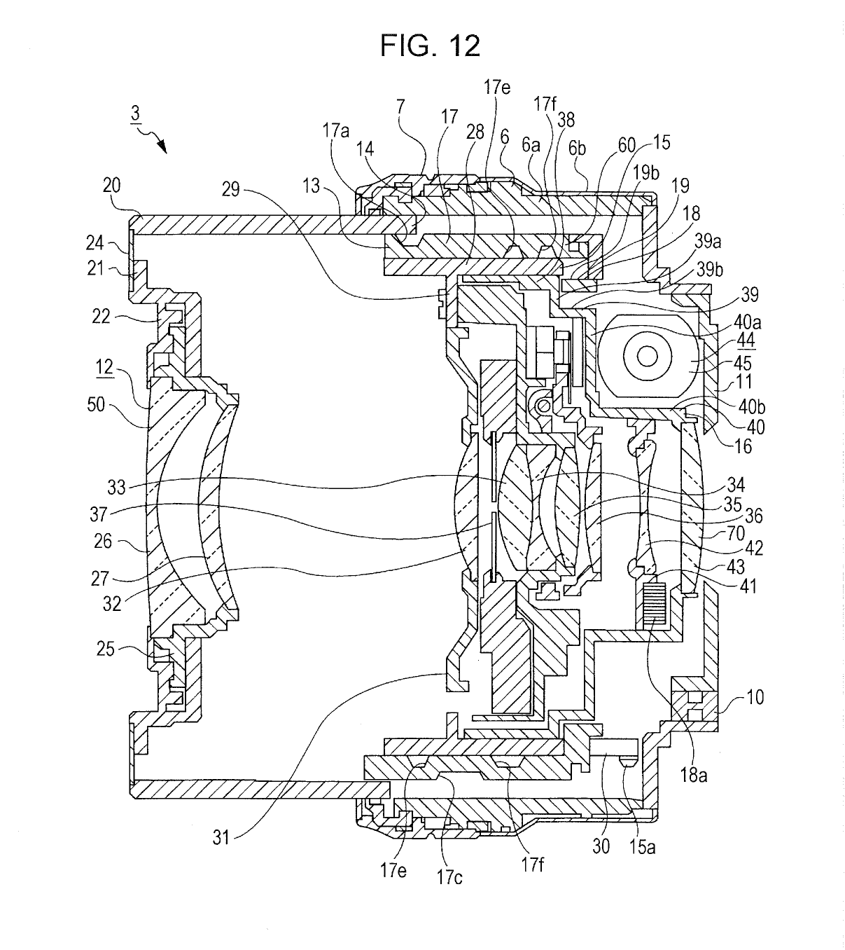

When the first group unit 50 is moved up to the front end, the lens barrel 3 is in a wide angle-end state in a zoom region (refer to FIG. 12), and thus the rotation of the driving motor 45 is stopped.

As described above, in the imaging apparatus 1, the engagement of the first cam engagement pins 14a with the first cam grooves 17a is switched over to the engagement of the second cam engagement pins 14b with the second cam grooves 17b in the movement region of the first group unit 50, and thus it is possible to increase the moving stroke of the first group unit 50 to that extent without performing multi-stage extension such as two-stage extension.

Zooming or focusing is performed by operating the operation ring 7 or the zoom lever 8 when the lens barrel 3 is in the wide angle-end state.

Also, hereinafter, an operation performed when zooming is performed and the lens barrel 3 is switched over from the wide angle-end state to the telephoto-end state will be shown as an example.

When the operation ring 7 or the zoom lever 8 is operated, the driving motor 45 is rotated again and the cam ring 13 is rotated in one direction.

If the cam ring 13 is rotated in one direction, the first group unit 50 is moved back and forth on the front end side of the movement region in such a way that the first cam engagement pins 14a of the first group moving ring 14 slide into the first cam grooves 17a of the cam ring 13. However, the position of the first group unit 50 in the telephoto-end state is disposed at the front end of the movement region in the same manner as the wide angle-end state.

Accordingly, description of an operation performed by the lens barrel 3 from the wide angle-end state to the telephoto-end state with regard to the second group unit 60 and the third group unit 70 will be shown below.

If the driving motor 45 is rotated and the cam ring 13 is rotated in one direction of the direction around the axis, the front-side cam engagement pins 15b of the second group moving ring 15 and the cam followers 16a of the third group moving ring 16 respectively slide into the second cam sliding grooves 17e and the third cam sliding grooves 17f, the movements of the second group moving ring 15 and the third group moving ring 16 are started to the front side, and thus the second group unit 60 and the third group unit 70 are moved to the front side.

If the second group unit 60 is moved to the front side, the protruding parts 30 and the rear-side cam engagement pins 15a of the second group moving ring 15 pass from the rear side to the front side of the insertion holes 19 of the cam ring 13. At this time, the protruding parts 30 pass through the first insertion parts 19a and the rear-side cam engagement pins 15a pass through the second insertion parts 19b.

In this way, the protruding parts 30 pass through the first insertion parts 19a and the rear-side cam engagement pins 15a pass through the second insertion parts 19b. Therefore, as described above, in correspondence with the parts of the insertion holes 19 which are passed through, the widths of the first insertion parts 19a in the direction perpendicular to the optical axis are less than the widths of the second insertion parts 19b in the direction perpendicular to the optical axis.

Accordingly, the widths of the respective parts of the insertion holes 19 in the optical axis direction are minimally formed, and thus it is possible to thicken the thickness of the cam ring 13, and thus it is possible to increase the stiffness of the cam ring 13 to that extent.

As described above, when the rear-side cam engagement pins 15a of the second group moving ring 15 pass through the second insertion parts 19b of the cam ring 13 from the back side to the front side, the rear-side cam engagement pins 15a are inserted into the first cam sliding grooves 17d of the cam ring 13 and slide into the first cam sliding grooves 17d. Accordingly, the second group moving ring 15 is moved to the front side in such a way that the rear-side cam engagement pins 15a slide into the first cam sliding grooves 17d and the front-side cam engagement pins 15b slide into the second cam sliding grooves 17e.

The second group unit 60 is moved up to the front end of the movement range. However, immediately before the second group unit 60 is moved up to the front end, the front-side cam engagement pins 15b of the second group moving ring 15 are positioned on the front side of the cam ring 13 and the engagement with the second cam sliding grooves 17e is released. Accordingly, in the state immediately before the second group unit 60 is moved up to the front end of the movement range, the second group unit 60 is moved to the front side in such a way that the rear-side cam engagement pins 15a slide into the first cam sliding grooves 17d.

On the other hand, the third group unit 70 is moved to the front side when the second group unit 60 is moved to the front side. However, the third group unit 70 is moved to the front side in such a way that the cam followers 16a slide into the third cam sliding grooves 17f of the cam ring 13, and thus the third group unit 70 is moved up to the front end of the movement range.

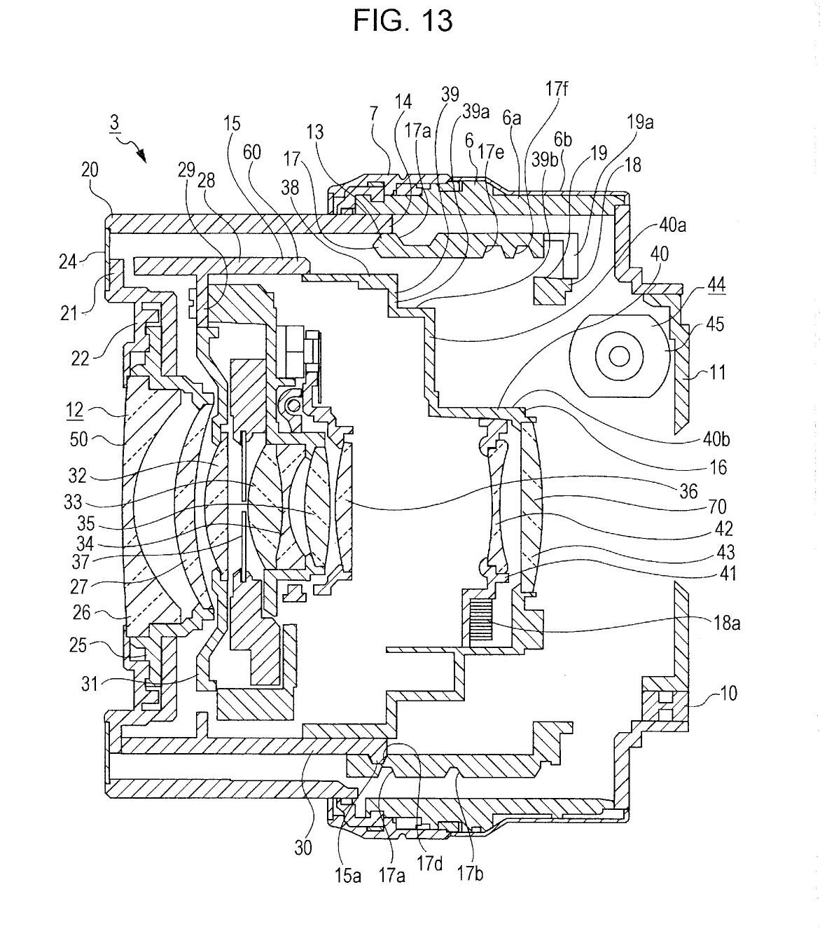

When the first group unit 50, the second group unit 60, and the third group unit 70 are moved up to the front end, the lens barrel 3 is in the telephoto-end state in a zoom range (refer to FIG. 13) and the rotation of the driving motor 45 is stopped.

As described above, in the imaging apparatus 1, engagement of the rear-side cam engagement pins 15a with the first cam sliding grooves 17d is switched over with the engagement of the front-side cam engagement pins 15b with the second cam sliding grooves 17e in the movement region of the second group unit 60. Accordingly, it is possible to increase the moving stroke of the second group unit 60 to that extent without performing multi-stage extension such as two-stage extension.

Subsequently, an operation performed by the lens barrel 3 from the telephoto-end state to the collapsed state through the wide angle-end state will be described.

When zooming is performed by operating the operation ring 7 or the zoom lever 8 and the state of the lens barrel 3 is switched over from the telephoto-end state to the wide angle-end state, the driving motor 45 is rotated in the reverse direction of the above direction and the cam ring 13 is rotated in the reverse direction.

When the cam ring 13 is rotated in the reverse direction, the first cam engagement pins 14a of the first group moving ring 14 slide into the first cam grooves 17a of the cam ring 13, and thus the first group unit 50 is moved back and forth on the front end side of the movement region. However, the position of the first group unit 50 in the wide angle-end state is the front end of the movement region as in the telephoto-end state.

In addition, when the driving motor 45 is rotated and the cam ring 13 is rotated in the reverse direction of the direction around the axis, the rear-side cam engagement pins 15a of the second group moving ring 15 and the cam followers 16a of the third group moving ring 16 respectively slide into the first cam sliding grooves 17d and the third cam sliding grooves 17f, the second group moving ring 15 and the third group moving ring 16 are started to move to the rear side, and thus the second group unit 60 and the third group unit 70 move to the rear side.

When the second group moving ring 15 is moved to the rear side, the front-side cam engagement pins 15b are inserted into the second cam sliding grooves 17e of the cam ring 13 and slide into the second cam sliding grooves 17e. Accordingly, the second group moving ring 15 is moved to the rear side in such a way that the rear-side cam engagement pins 15a slide into the first cam sliding grooves 17d and the front-side cam engagement pins 15b slide into the second cam sliding grooves 17e.

When the second group unit 60 is moved to the rear side, the protruding parts 30 of the second group moving ring 15 and the rear-side cam engagement pins 15a are inserted into the insertion holes 19 of the cam ring 13 from the front side to the rear side. At this time, the protruding parts 30 are inserted into the first insertion parts 19a, and the rear-side cam engagement pins 15a are inserted into the second insertion parts 19b.

When the rear-side cam engagement pins 15a are inserted into the second insertion parts 19b of the cam ring 13 from the front side to the rear side, the rear-side cam engagement pins 15a are positioned on the rear side of the cam ring 13, and thus engagement with the first cam sliding grooves 17d is released. Accordingly, in a state immediately before the second group unit 60 is moved up to the rear end of the movement range, the second group unit 60 is moved to the rear side in such a way that the front-side cam engagement pins 15b slide into the second cam sliding grooves 17e.

On the other hand, when the third group unit 70 is moved to the rear side of the second group unit 60, the third group unit 70 is moved to the rear side in such a way that the cam followers 16a slide into the third cam sliding grooves 17f of the cam ring 13, and thus the third group unit 70 is moved up to the rear end of the movement range.

When the first group unit 50 is positioned at the front end and the second group unit 60 and the third group unit 70 are moved up to the rear end, the lens barrel 3 is in the wide angle-end state in the zooming region (refer to FIG. 12), and thus the rotation of the driving motor 45 is stopped.

When the input operation unit (power button) 4a of the apparatus main body 2 is operated and the supply of power is stopped, the driving motor 45 is rotated in the reverse direction immediately before the supply of power is stopped and the cam ring 13 is rotated in the reverse direction of the direction around the axis.

If the cam ring 13 is rotated in the reverse direction, the first cam engagement pins 14a of the first group moving ring 14 slide into the first cam grooves 17a, the first group moving ring 14 is started to move to the rear side, and thus the first group unit 50 is moved to the rear side.

If the first group unit 50 is moved to the rear side, the second cam engagement pins 14b of the first group moving ring 14 are inserted into the second cam grooves 17b of the cam ring 13 and slide into the second cam grooves 17b. Accordingly, the first group moving ring 14 is moved to the rear side in such a way that the first cam engagement pins 14a slide into the first cam grooves 17a and the second cam engagement pins 14b slide into the second cam grooves 17b.

The first group unit 50 is moved up to the rear end of the movement range. However, immediately before the first group unit 50 is moved up to the rear end, the first cam engagement pins 14a of the first group moving ring 14 are positioned on the rear side of the cam ring 13 and engagement with the first cam grooves 17a is released. Accordingly, in the state immediately before the first group unit 50 is moved up to the rear end of the movement range, the first group unit 50 is moved to the rear side in such a way that the second cam engagement pins 14b slide into the second cam grooves 17b.

At this time, the front-side cam engagement pins 15b of the second group moving ring 15 and the cam followers 16a of the third group moving ring 16 respectively slide into the second cam sliding grooves 17e and the third cam sliding grooves 17f. However, since the front-side cam engagement pins 15b and the cam followers 16a respectively slide into the parts of the second cam sliding grooves 17e and the third cam sliding grooves 17f, which are extended in the direction perpendicular to the optical axis, the second group moving ring 15 and the third group moving ring 16 are not moved in the optical axis direction.

When the second lens group 60 and the third lens group 70 are positioned at the rear end and the first group unit 50 is moved up to the rear end (refer to FIG. 5), the lens barrel is in the collapsed state, and thus the rotation of the driving motor 45 is stopped.

### Embodiment of Imaging Apparatus

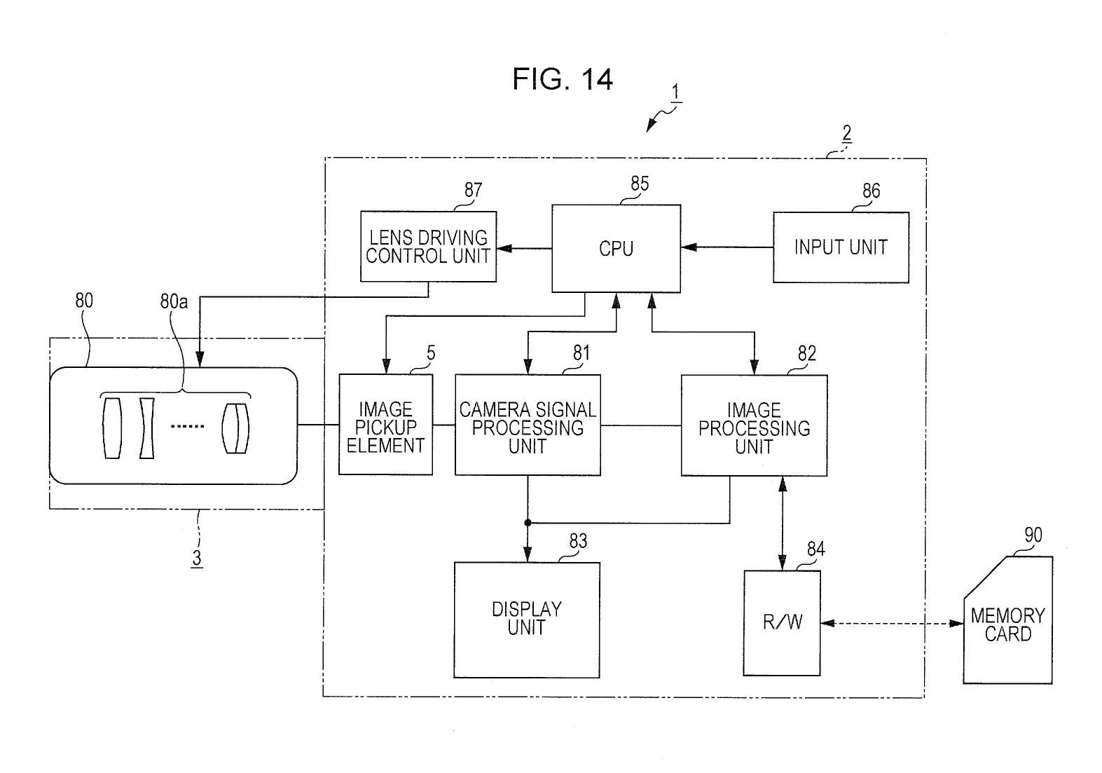

FIG. 14 is a block diagram illustrating the interchangeable lens-type digital camera of the imaging apparatus according to an embodiment of the present technology.

The imaging apparatus (digital camera) 1 includes a camera block 80 which performs an imaging function, a camera signal processing unit 81 which performs a signal process, such as analog-digital conversion or the like, on a photographed image signal, and an image processing unit 82 which performs recoding and reproduction processes on the image signal. In addition, the imaging apparatus 1 includes a display unit 83, such as a Liquid Crystal Display (LCD), which displays a photographed image or the like, a Reader/Writer (R/W) 84 which writes and reads the image signal on and from a memory card 90, a Central Processing Unit (CPU) 85 which controls the overall imaging apparatus 1, an input unit 86 which includes various input operation units 4a, 4a, . . . and the like on which necessary operations are performed by the user, and a lens driving control unit 87 which controls the driving of optical elements (lenses 26, 27, 32, 33, 34, 35, 36, 37, 42, 43, and the like) 80a, such as lenses, which are disposed in the camera block 80, and a lens group.

The camera signal processing unit 81 performs various signal processes, such as conversion into a digital signal, noise removal, image quality correction, conversion into brightness or color-difference signal, on the output signal from the imaging device 5.

The image processing unit 82 performs a compression coding/extension decoding process on the image signal based on a predetermined image data format or performs a conversion process on data specification such as resolution.

The display unit 83 includes a function of displaying various data, such as a state of an operation performed on the input unit 86 by the user and a photographed image.

The R/W 84 writes image data which is encoded by the image processing unit 82 on the memory card 90, and reads the image data which is recorded in the memory card 90.

The CPU 85 functions as a control processing unit which controls each circuit block provided in the imaging apparatus 1, and controls each circuit block based on an indication input signal from the input unit 86.

The input unit 86 outputs the indication input signal according to an operation performed by the user to the CPU 85.

The lens driving control unit 87 controls a motor, which drives each lens of an optical system 80a and which is not shown in the drawing, or the like based on the control signal from the CPU 85.

The memory card 90 is, for example, a semiconductor memory which is detachable from a slot connected to the R/W 84.

Hereinafter, an operation performed by the imaging apparatus 1 will be described.

In a photography standby state, an image signal which is photographed by the camera block 80 is output to the display unit 83 through the camera signal processing unit 81, and is displayed as a camera still image under the control of the CPU 85. In addition, if an indication input signal from the input unit 86 is input in order to perform zooming, the CPU 85 outputs a control signal to the lens driving control unit 87, and a predetermined lens or a lens group of the optical system 80a is moved based on the control of the lens driving control unit 87.

If a shutter, which is not shown in the drawing, of the camera block 80 is operated based on the indication input signal from the input unit 86, the photographed image signal is output from the camera signal processing unit 81 to the image processing unit 82, a compression encoding process is performed on the photographed image signal, and the photographed image signal is converted into digital data which has a predetermined data format. The data obtained through the conversion is output to the R/W 84, and is written into the memory card 90.

For example, when the input operation unit (shutter button) 4a of the input unit 86 is half-way pressed or when the input operation unit 4a is fully pressed in order to perform recording (photographing), focusing is performed in such a way that the lens driving control unit 87 causes a predetermined lens or a lens group of the optical system 80a to be moved based on the control signal from the CPU 85.

When image data which is recorded in the memory card 90 is reproduced, predetermined image data is read from the memory card 90 by the R/W 84 in accordance with an operation performed on the input unit 86 and the extension decoding process is performed by the image processing unit 82. Thereafter, a reproduced image signal is output to the display unit 83 and the reproduced image is displayed.

### Conclusion

As mentioned above, in the imaging apparatus 1, the rear-side cam engagement pins 15a and the front-side cam engagement pins 15b of the second group moving ring 15 are separately positioned in the optical axis direction, one side of the rear-side cam engagement pins 15a and the front-side cam engagement pins 15b is engaged with the first cam sliding grooves 17d or the second cam sliding grooves 17e of the cam ring 13 in at least a part of the movement range of the second group moving ring 15.

Accordingly, in the movement range of the second group moving ring 15, the engagement of the rear-side cam engagement pins 15a with the first cam sliding grooves 17d is switched over to the engagement of the front-side cam engagement pins 15b with the second cam sliding grooves 17e. Therefore, it is not necessary to perform multi-stage extension, such as two-stage extension, and it is possible to achieve miniaturization of the lens barrel 3 while the sufficient moving stroke of the second group moving ring 15 is secured.

In addition, in the imaging apparatus 1, the engagement of the first cam engagement pins 14a with the first cam grooves 17a is switched over to the engagement of the second cam engagement pins 14b with the second cam grooves 17b in the movement range of the first group moving ring 14. Therefore, it is not necessary to perform multi-stage extension, such as two-stage extension, and it is possible to achieve the miniaturization of the lens barrel 3 while the sufficient moving stroke of the first group moving ring 14 is secured.

Further, in the imaging apparatus 1, the cam ring 13 is formed with the insertion holes 19, 19, 19 into which the protruding parts 30, 30, 30 of the second group moving ring 15 and the rear-side cam engagement pins 15a, 15a, 15a are inserted.

Accordingly, it is possible to increase the moving stroke of the second group moving ring 15 while the length of the cam ring 13 in the optical axis direction is reduced, and it is possible to achieve miniaturization by securing a space for components on the rear side of the cam ring 13 of the inside of the lens barrel 3.

### Present Technology

The present technology can be configured as follows:

(1) A lens barrel including: a cam ring that includes a first cam sliding part and a second cam sliding part, and that is rotated in a direction around an optical axis; a fixing and holding barrel in which the cam ring is disposed; a moving ring that includes a first cam engagement part which is slidably engaged with the first cam sliding part and a second cam engagement part which is slidably engaged with the second cam sliding part, and that is moved in an optical axis direction by rotation of the cam ring; and an optical element that is moved in connection with movement of the moving ring, the first cam engagement part and the second cam engagement part are separately positioned in the optical axis direction, and, in at least a part of a movement range of the moving ring, one of the first cam engagement part and the second cam engagement part is engaged with the first cam sliding part or the second cam sliding part, and another one of the first cam engagement part and the second cam engagement part is positioned on an outside of the cam ring in the optical axis direction.

(2) The lens barrel according to (1), the moving ring includes a barrel part which is penetrated in the optical axis direction, and protruding parts which protrude from the barrel part in the optical axis direction, cam engagement pins, which respectively protrude from the protruding parts, are provided as the first cam engagement part and the second cam engagement part, the first cam engagement part is more closely positioned on an image side in the optical axis direction than the second cam engagement part, and the cam ring is formed with insertion holes into which the protruding parts and the first cam engagement part are inserted and which are penetrated in the optical axis direction.

(3) The lens barrel according to (2), the insertion holes include first insertion parts into which the protruding parts are inserted, and second insertion parts into which the first cam engagement parts are inserted, and a width of the first insertion part in a direction perpendicular to an optical axis is less than a width of the second insertion part in a direction perpendicular to the optical axis.

(4) The lens barrel according to any one of (1) to (3), the cam ring is formed with a third cam sliding part, and the moving ring is provided with a third cam engagement part which is slidably engaged with the third cam sliding part, and which is present in the same position as the first cam engagement part or the second cam engagement part in the optical axis direction or is present near to the first cam engagement part or the second cam engagement part.

(5) The lens barrel according to any one of (1) to (4), the cam ring is provided with a driving mechanism which supplies driving force, and the driving mechanism is disposed inside the fixing and holding barrel.

(6) The lens barrel according to (5), the driving mechanism is provided with a driving motor and a circuit board which controls the driving motor, the first cam engagement part is positioned on an outer circumferential side of the optical element, and the driving motor and the circuit board are disposed between the first cam engagement part and the optical element.

(7) An imaging apparatus including: a lens barrel in which an optical system is disposed; and an imaging device that converts an optical image, which is captured through the optical system, into an electrical signal, the lens barrel includes: a cam ring that includes a first cam sliding part and a second cam sliding part, and that is rotated in a direction around an optical axis; a fixing and holding barrel in which the cam ring is disposed; a moving ring that includes a first cam engagement part which is slidably engaged with the first cam sliding part and a second cam engagement part which is slidably engaged with the second cam sliding part, and that is moved in an optical axis direction by rotation of the cam ring; and an optical element that is moved in connection with movement of the moving ring, the first cam engagement part and the second cam engagement part are separately positioned in the optical axis direction, and, in at least a part of a movement range of the moving ring, one of the first cam engagement part and the second cam engagement part is engaged with the first cam sliding part or the second cam sliding part, and another one of the first cam engagement part and the second cam engagement part is positioned on an outside of the cam ring in the optical axis direction.

The detailed figure and structure of each unit shown in the above-described best mode is just one example of embodiments when the present technology is put into implementation, and the technical range of the present technology is not limitedly interpreted thereby.

The present disclosure contains subject matter related to that disclosed in Japanese Priority Patent Application JP 2012-225164 filed in the Japan Patent Office on Oct. 10, 2012, the entire contents of which are hereby incorporated by reference.

What is claimed is:

1. A lens barrel comprising:
a cam ring that includes a first cam sliding part and a second cam sliding part, and that is rotated in a direction around an optical axis;
a fixing and holding barrel in which the cam ring is disposed;
a moving ring that includes a first cam engagement part which is slidably engaged with the first cam sliding part and a second cam engagement part which is slidably engaged with the second cam sliding part, and that is moved in an optical axis direction by rotation of the cam ring; and
an optical element that is moved in connection with movement of the moving ring,
wherein the first cam engagement part and the second cam engagement part are separately positioned in the optical axis direction, and
wherein, in at least a part of a movement range of the moving ring, one of the first cam engagement part and the second cam engagement part is engaged with the first cam sliding part or the second cam sliding part, and another one of the first cam engagement part and the second cam engagement part is positioned on an outside of the cam ring in the optical axis direction.

2. The lens barrel according to claim 1,
wherein the moving ring includes a barrel part which is penetrated in the optical axis direction, and protruding parts which protrude from the barrel part in the optical axis direction,
wherein cam engagement pins, which respectively protrude from the protruding parts, are provided as the first cam engagement part and the second cam engagement part,
wherein the first cam engagement part is more closely positioned on an image side in the optical axis direction than the second cam engagement part, and
wherein the cam ring is formed with insertion holes into which the protruding parts and the first cam engagement part are inserted and which are penetrated in the optical axis direction.

3. The lens barrel according to claim 2,
wherein the insertion holes include first insertion parts into which the protruding parts are inserted, and second insertion parts into which the first cam engagement parts are inserted, and
wherein a width of the first insertion part in a direction perpendicular to an optical axis is less than a width of the second insertion part in a direction perpendicular to the optical axis.

4. The lens barrel according to claim 1,
wherein the cam ring is formed with a third cam sliding part, and
wherein the moving ring is provided with a third cam engagement part which is slidably engaged with the third cam sliding part, and which is present in the same position as the first cam engagement part or the second cam engagement part in the optical axis direction or is present near to the first cam engagement part or the second cam engagement part.

5. The lens barrel according to claim 1,
wherein the cam ring is provided with a driving mechanism which supplies driving force, and
wherein the driving mechanism is disposed inside the fixing and holding barrel.

6. The lens barrel according to claim 5,
wherein the driving mechanism is provided with a driving motor and a circuit board which controls the driving motor,
wherein the first cam engagement part is positioned on an outer circumferential side of the optical element, and
wherein the driving motor and the circuit board are disposed between the first cam engagement part and the optical element.

7. An imaging apparatus comprising:
a lens barrel in which an optical system is disposed; and
an imaging device that converts an optical image, which is captured through the optical system, into an electrical signal,
wherein the lens barrel includes:
a cam ring that includes a first cam sliding part and a second cam sliding part, and that is rotated in a direction around an optical axis;
a fixing and holding barrel in which the cam ring is disposed;
a moving ring that includes a first cam engagement part which is slidably engaged with the first cam sliding part and a second cam engagement part which is slidably engaged with the second cam sliding part, and that is moved in an optical axis direction by rotation of the cam ring; and
an optical element that is moved in connection with movement of the moving ring,
wherein the first cam engagement part and the second cam engagement part are separately positioned in the optical axis direction, and
wherein, in at least a part of a movement range of the moving ring, one of the first cam engagement part and the second cam engagement part is engaged with the first cam sliding part or the second cam sliding part, and another one of the first cam engagement part and the second cam engagement part is positioned on an outside of the cam ring in the optical axis direction.
